(19) United States
(12) Patent Application Publication
(10) Pub. No.: US 2008/0136808 A1
(43) Pub. Date: Jun. 12, 2008

(54) Method and System for Illuminating a Display Screen of a Handheld Electronic Device

(75) Inventors: Yucheng Jin, Chalfont, PA (US); David L. Ellis, Lilburn, GA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/609,491

(22) Filed: Dec. 12, 2006

(51) Int. Cl. G09G 5/00

(52) U.S. Cl. 345/214

(57) ABSTRACT

A method (400) and system for illuminating a display screen (106) of a handheld electronic device (100) is disclosed. The system includes a transparent display screen cover (104), which is movably coupled to a housing (102) of the handheld electronic device. Further, the system includes at least one switch (206). The at least one switch is actuated in response to a user contacting the transparent display screen cover. The system also includes a control circuit (204), which causes the illumination of the display screen, in response to the activation of the at least one switch.

### FIELD OF THE INVENTION

The present invention relates in general to the field of handheld electronic devices, and more specifically, to a method and system for illuminating a display screen of a handheld electronic device.

### BACKGROUND OF THE INVENTION

Handheld electronic devices are becoming increasingly popular. Typically, a handheld electronic device is pocket-sized and portable. These handheld electronic devices can perform a wide range of functions. Some of these functions include, for example, computing, communicating, sharing information, data processing and gaming. Examples of handheld electronic devices include, but are not limited to, calculators, mobile phones, cordless phones and Personal Digital Assistants (PDAs). Further, these electronic devices can include a user interface, for example, a keypad, a joystick, a touch screen and/or a display screen, to enable the user to get the desired output from the device.

A handheld electronic device also includes a display screen to display information to the user operating the device. The display screen can be, for example, a Liquid Crystal Display (LCD) screen, a Thin Film Transistor (TFT) screen or a plasma screen. If the handheld device is, for example, a mobile phone, the information displayed on the screen can include a caller identification (ID), a phone number, the time of the call, a text message, a picture, a gaming interface and a list of the available functions of the mobile phone. However, if the area surrounding the handheld electronic device is dark, the information displayed on the screen may not be clearly visible to the user. Therefore, the screen needs to be illuminated, to display the information on it. Conventionally, a display screen can be illuminated by using a back-lighting system that is controlled by a control circuit in the handheld device. In a mobile phone, this back-lighting can be activated when, for example, a call is received, by a special key or one or more keys being pressed on the keypad.

However, the display screen is only illuminated for a predefined time period, to save the battery power of the handheld electronic device, after which the illumination is turned off. A key on the keypad of the handheld electronic device needs to be pressed to illuminate the display screen again. Some conventional handheld electronic devices use a dedicated key to illuminate the display screen. However, locating the dedicated key on the keypad of the handheld electronic device may be difficult in the dark.

Some handheld electronic devices use the existing keys on the keypad of the device to illuminate the display screen. Any key or a combination of keys on the keypad can be pressed to illuminate the screen. However, pressing these keys more than once or in the wrong order can result in a situation where a key reverts to its primary functionality. Consequently, a user can initiate a function that he/she does not intend.

In light of the above, there is a need for a user-friendly and effective method and system for illuminating the display screen of a handheld electronic device. The system should not require the use of a dedicated key, which is difficult to locate in the dark, to illuminate the display screen. Moreover, the system should not require the use of the existing keys on the keypad of the handheld electronic device to illuminate the display screen, to prevent the initiation of any function the user does not intend.

### SUMMARY

In one embodiment, a system for illuminating a display screen of a handheld electronic device is provided. The system includes a transparent display screen cover. This transparent display screen cover is movably coupled to a housing of the handheld electronic device. The system also includes at least one switch, which is actuated in response to a user contacting the transparent display screen cover. Further, the system includes a control circuit, which causes the illumination of the display screen, in response to the actuation of the at least one switch.

For another embodiment, a method for illuminating a display screen of a handheld electronic device is provided. The method includes actuating at least one switch, which is coupled to a transparent display screen cover. Further, the method includes generating a signal when the at least one switch is actuated in response to a user contacting the transparent display screen cover. Moreover, the method includes processing the generated signal. The method also includes illuminating the display screen in response to the processed signal.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates a block diagram of an exemplary handheld electronic device, in accordance with an embodiment of the present invention;

FIG. 2 illustrates a cross-sectional view of an exemplary handheld electronic device, in accordance with an embodiment of the present invention;

FIG. 3 illustrates a cross-sectional view of an exemplary handheld electronic device, in accordance with another embodiment of the present invention; and

FIG. 4 is a flow diagram illustrating a method for illuminating a display screen of an exemplary handheld electronic device, in accordance with an embodiment of the present invention.

### DETAILED DESCRIPTION

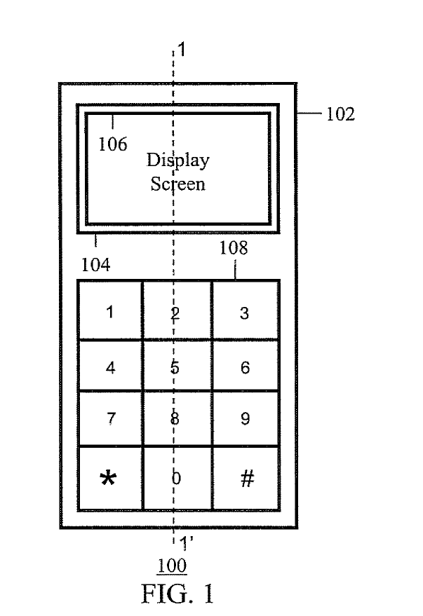

FIG. 1 illustrates a block diagram of an exemplary handheld electronic device 100, in accordance with an embodiment of the present invention. The handheld electronic device 100 can be, for example, a calculator, a cordless phone, a mobile phone, a Personal Digital Assistant (PDA), or any other wireless communication device. The handheld electronic device 100 can include a housing 102, a transparent display screen cover 104, a display screen 106, and a keypad 108. The transparent display screen cover 104 is provided to protect the display screen 106 from any external damage. In one embodiment, the display screen 106 can be a Liquid Crystal Display (LCD) screen. The display screen 106 can display information that can include, for example, a caller identification (ID), a phone number, the time of a call, a text message, a picture, a gaming interface, a list of the functions available on the mobile phone, and/or the current definition of a key on the keypad 108. In one embodiment, the keypad 108 can be a rubber keypad. The keypad 108 can be connected to, for example, a dome array keypad that is placed under the keypad 108 of the handheld electronic device 100. When a key from a plurality of keys on the keypad 108 is pressed, the dome array keypad generates a signal that corresponds to a function performed by the key. A control circuit executes the function of the pressed key when the signal is processed.

The display screen 106 of the handheld electronic device 100 is illuminated to enable a user to view the information displayed on the display screen 106. The display screen 106 is illuminated for a predefined time period. To illuminate the display screen 106 after the predefined time period, the user can press a key on the keypad 108 of the handheld electronic device 100. When the key is pressed, the display screen 106 is illuminated again.

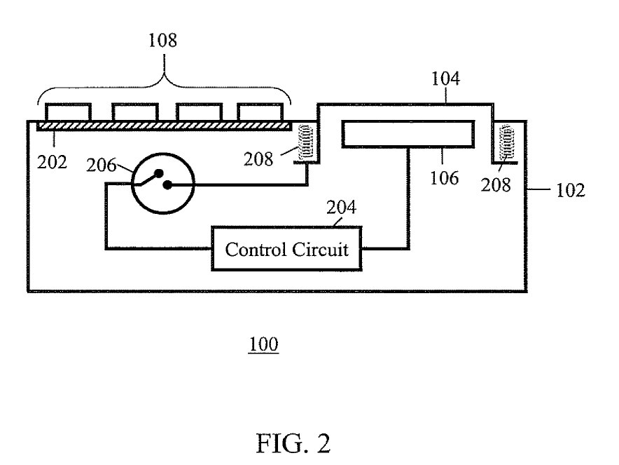

FIG. 2 illustrates a cross-sectional view along the axis 1-1′ of the exemplary handheld electronic device 100, in accordance with an embodiment of the present invention. The handheld electronic device 100 can include the housing 102, the transparent display screen cover 104, the display screen 106, the keypad 108, a dome array keypad 202, a control circuit 204, at least one switch 206, and a pair of springs 208. The at least one switch 206 can be a touch-sensitive switch, a mechanical switch, an electronic switch or an electromechanical switch. In one embodiment, the transparent display screen cover 104 is movably coupled to the housing 102 by using the pair of springs 208. However, it will be apparent to a person skilled in the art that one or more springs can be used to movably couple the transparent display screen cover 104 to the housing 102. For another embodiment, an elastic material, for example, rubber or latex, or any other mechanical arrangement, can be used to movably couple the transparent display screen cover 104 to the housing 102. Further, the keypad 108 is connected to the dome array keypad 202. The transparent display screen cover 104 is connected to the at least one switch 206. Furthermore, the at least one switch 206 can be activated in response to the movement of the moveable coupled transparent display screen cover 104. The at least one switch 206 is connected to the control circuit 204. Additionally, the control circuit 204 is connected to the display screen 106.

In one embodiment, a user operating the handheld electronic device 100 can illuminate the display screen 106 by mechanically depressing the transparent display screen cover 104. When the transparent display screen cover 104 is depressed, the at least one switch 206 is activated. Further, a signal is generated by the at least one switch 206 when the user depresses the transparent display screen cover 104. The generated signal is processed by the control circuit 204, causing the display screen 106 to be illuminated. The illumination can last for a predefined time period, for example, a minute. To illuminate the display screen 106 after the predefined time period, the user has to depress the transparent display screen cover 104 again.

For another embodiment, a user operating the handheld electronic device 100 can illuminate the display screen 106 by mechanically depressing and then releasing contact with the transparent display screen cover 104. A signal is generated by the at least one switch 206 when the user releases contact with the transparent display screen cover 104. The generated signal is processed by the control circuit 204. The control circuit 204 causes the display screen 106 to be illuminated when the signal is processed. The illumination can last for a predefined time period, for example, a minute. To illuminate the display screen 106 after the predefined time period, the user needs to contact the transparent display screen cover 104 again. The signal is generated by the at least one switch 206 when contact with the transparent display screen 104 is released.

For yet another embodiment, a user operating the handheld electronic device 100 can illuminate the display screen 106 by mechanically depressing and keeping the transparent display screen cover 104 depressed for the desired time duration. A signal is generated by the at least one switch 206 for the time during which the user is in contact with the transparent display screen cover 104. The generated signal is processed by the control circuit 204, which causes the illumination of the display screen 106 when the signal is processed. The illumination lasts for the duration of the user's contact with the transparent display screen cover 104.

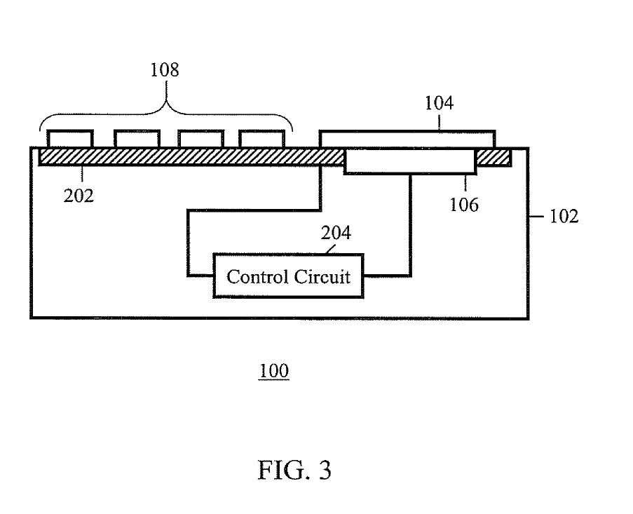

FIG. 3 illustrates a cross-sectional view along the axis 1-1′ of the exemplary handheld electronic device 100, in accordance with another embodiment of the present invention. The handheld electronic device 100 can include the housing 102, the transparent display screen cover 104, the display screen 106, the keypad 108, the dome array keypad 202, and the control circuit 204. The transparent display screen cover 104 is movably coupled to the housing 102 of the handheld electronic device 100 and is also coupled to the dome array keypad 202. The dome array keypad 202 is extended from its conventional length so that it can be coupled to the transparent display screen cover 104. The transparent display screen cover 104, in this case, acts as a key and has a particular functionality. Further, the dome array keypad 202 is connected to the control circuit 204. Furthermore, the control circuit 204 is connected to the display screen 106.

In one embodiment, a user operating the handheld electronic device 100 can illuminate the display screen 106 by mechanically depressing the transparent display screen cover 104. Further, a signal is generated by the dome array keypad 202 when the user depresses the transparent display screen cover 104. The generated signal is processed by the control circuit 204. The control circuit 204 causes the illumination of the display screen 106 for a predefined time period when the signal is processed. To illuminate the display screen 106 after the predefined time period, the user has to depress the transparent display screen cover 104 again.

In another embodiment, a user operating the handheld electronic device 100 can illuminate the display screen 106 by mechanically depressing and then releasing contact with the transparent display screen cover 104. A signal is generated by the dome array keypad 202 when the user releases contact with the transparent display screen cover 104. The generated signal is processed by the control circuit 204. The control circuit 204 causes the illumination of the display screen 106 when the signal is processed. The illumination lasts for a predefined time period. To illuminate the display screen 106 after the predefined time period, the user has to depress the transparent display screen cover 104 again. The signal for illuminating the display screen 106 is generated by the dome array keypad 202 when contact with the transparent display screen 104 is released.

In yet another embodiment, a user operating the handheld electronic device 100 can illuminate the display screen 106 by mechanically depressing the transparent display screen 104 and keeping it depressed for the desired time duration. A signal is generated by the dome array keypad 202 for the time duration of the user's contact with the transparent display screen cover 104. The generated signal is processed by the control circuit 204, which causes the illumination of the display screen 106 when the signal is processed. The illumination lasts for the duration of the user's contact with the transparent display screen cover 104.

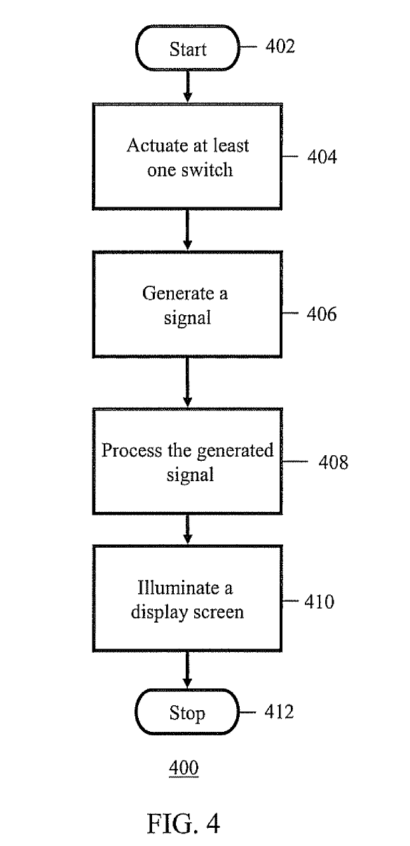

FIG. 4 is a flow diagram illustrating a method 400 for illuminating the display screen 106 of the exemplary handheld electronic device 100, in accordance with an embodiment of the present invention. At step 402, the method 400 is initiated. At step 404, the at least one switch 206 is actuated when a user contacts the transparent display screen cover 104. In one embodiment, contacting the transparent display screen cover 104 includes mechanically depressing it. For another embodiment, contacting the transparent display screen cover 104 includes mechanically depressing and then releasing the transparent display screen cover 104. For yet another embodiment, contacting the transparent display screen cover 104 includes mechanically depressing the transparent display screen cover 104 and keeping it depressed for a desired time period. At step 406, a signal is generated by the at least one switch 206 when the user contacts the transparent display screen cover 104. At step 408, the generated signal is processed by the control circuit 204. At step 410, the control circuit 204 causes the illumination of the display screen 106 when the signal is processed. The illumination lasts for a predefined time period, for example, a minute. A user can illuminate the display screen 106 after the predefined time period by contacting the transparent display cover 106 again. At step 412, the method 400 is terminated.

Various embodiments, as described above, provide a method and system for illuminating a display screen of a handheld electronic device. The present invention eliminates the need to locate a dedicated key on the keypad of a handheld electronic device, to illuminate the display screen in the dark. The transparent display screen cover, being the noticeably visible part of the handheld electronic device, is easy to locate, even in the dark. Further, mechanically depressing the transparent display screen cover more than once does not initiate any unwanted function that a user did not intend to activate.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A system for illuminating a display screen of a handheld electronic device, the system comprising:
a transparent display screen cover movably coupled to a housing of the handheld electronic device;
at least one switch actuated in response to a user contacting the transparent display screen cover; and
a control circuit, wherein the control circuit causes an illumination of the display screen in response to the actuation of the at least one switch.

2. The system as recited in claim 1, wherein the handheld electronic device is a wireless communication device.

3. The system as recited in claim 1, wherein the contact of the transparent display screen cover by the user comprises mechanically depressing the transparent display screen cover.

4. The system as recited in claim 1, wherein the at least one switch is a touch sensitive electronic switch.

5. The system as recited in claim 1, wherein the transparent display screen cover is coupled to the at least one switch, and wherein the at least one switch generates a signal indicative of actuation at the initiation of the user contacting the transparent display screen cover.

6. The system as recited in claim 5, wherein the signal is processed by the control circuit to cause the illumination of the display screen for a predefined time period.

7. The system as recited in claim 1, wherein the at least one switch generates a signal indicative of actuation upon the termination of the user contacting the transparent display screen cover.

8. The system as recited in claim 7, wherein the signal is processed by the control circuit to cause the illumination of the display screen for a predefined time period.

9. The system as recited in claim 1, wherein the at least one switch generates a signal for a duration of the user contact with the transparent display screen cover.

10. The system as recited in claim 9, wherein the signal is processed by the control circuit to cause the illumination of the display screen for the duration of the user contact with the transparent display screen cover.

11. A method for illuminating a display screen of a handheld electronic device, the method comprising:
actuating at least one switch, wherein the at least one switch is coupled to a transparent display screen cover;
generating a signal when the at least one switch is actuated in response to a user contacting the transparent display screen cover;
processing the generated signal; and
illuminating the display screen in response to the processed signal.

12. The method as recited in claim 11, wherein actuating the at least one switch comprises mechanically depressing the transparent display screen cover.

13. The method as recited in claim 11, wherein the signal is generated at the initiation of the user contacting the transparent display screen cover.

14. The method as recited in claim 13, further comprising illuminating the display screen for a predefined time period in response to processing of the signal.

15. The method as recited in claim 11, wherein the signal is generated at the termination of the user contacting the transparent display screen cover.

16. The method as recited in claim 15, further comprising illuminating the display screen for a predefined time period in response to the processing of the signal.

17. The method as recited in claim 11, wherein the signal is generated for a duration of the user contacting the transparent display screen cover.

18. The method as recited in claim 17, further comprising illuminating the display screen for the duration of the user contacting the transparent display screen cover in response to the processing of the signal.
